(19) United States
(12) Patent Application Publication
(10) Pub. No.: US 2026/0050951 A1
(43) Pub. Date: Feb. 19, 2026

(54) SYSTEMS AND METHODS FOR CROWDFUNDED AUCTIONS, TOKENIZED REWARD DISTRIBUTION IN AUCTIONS, AND INCENTIVIZED AUCTION PARTICIPATION

(71) Applicant: Imagifund Technologies, LLC, Sheridan, WY (US)

(72) Inventors: Dustin Taylor, Douglasville, GA (US); Jessica Elaine Parker, Douglasville, GA (US); Donald J. Fiechter, Scottsdale, AZ (US); Aaron Moore, Chamblee, GA (US); George McClain, Maidsville, WV (US)

(73) Assignee: Imagifund Technologies, LLC, Sheridan, WY (US)

(21) Appl. No.: 19/299,811

(22) Filed: Aug. 14, 2025

Related U.S. Application Data
(60) Provisional application No. 63/683,584, filed on Aug. 15, 2024.

(51) Int. Cl. G06Q 30/0279; G06Q 20/06; G06Q 20/36; G06Q 20/42; G06Q 30/0207; G06Q 30/08; G06Q 40/06

(52) U.S. Cl. CPC G06Q 30/0279; G06Q 20/06; G06Q 20/36; G06Q 20/42; G06Q 30/0239; G06Q 30/08; G06Q 40/068; G06Q 2220/00

(57) ABSTRACT

Multi-phase crowdfunding systems and methods include goal-verified funding with real-time transaction confirmation. Issuance of reward points are optionally fungibly paired with blockchain tokens. Exclusive reward fulfillment is provided via user-determined auction mechanics. Overpledged funds can be automatically allocated. A replay auction mechanism enables retained participation through persistent bid units. A non-cash bidding economy is restricted to validated contributors.

### CROSS-REFERENCE TO RELATED APPLICATIONS

This application claims the benefit of priority to U.S. Provisional Ser. No. 63/683,584 filed Aug. 15, 2024 the content of which is incorporated by reference herein in its entirety.

### BACKGROUND

### 1. Field

The present disclosure relates to systems and methods for auctions, and more particularly to systems and methods for ensuring reserves are met, and incentivizing participation in online auctions.

### 2. Description of Related Art

Conventional crowdfunding platforms typically operate using a binary success/failure model: if a campaign meets its pledge goal, funds are collected and the campaign proceeds; if not, the campaign is canceled and no funds are collected. These platforms fail to address scenarios in which a campaign meets its goal but suffers from incomplete or failed payment processing, leading to funding shortfalls. Additionally, conventional online crowdfunding platforms, including penny auctions and the like, often fail to garner enough participation to make bidding for an auction engaging, fun or exciting for participants.

The conventional techniques have been considered satisfactory for their intended purpose. However, there is an ever-present need for improved systems and methods for online auctions. This disclosure provides a solution for this need.

### SUMMARY

A system for providing auction campaigns includes one or more processors. Memory stores instructions that, when executed by the one or more processors, cause the system to receive, from a first user device associated with a campaigner, a campaign request, the campaign request comprising an indication of an item or service for offer and a reserve price. The instructions cause the system to publish, via a first graphical user interface, the indication of the item or service for offer in association with a campaign, and to receive, from a plurality of second user devices, a plurality of pledges associated with the campaign within a first predetermined time period. Responsive to determining that a sum of the pledges received from the plurality of second user devices within the first predetermined time period exceeds the reserve price, the instructions cause the system to validate the plurality of pledges within a second predetermined time period to generate a validated pledge sum. Responsive to determining that the validated pledge sum exceeds the reserve price, the instructions cause the system to transmit a notification to each user device of the plurality of second user devices that is associated with a validated pledge, the notification comprising a scheduled time for an auction of the item or service for auction, and upon the occurrence of the scheduled time, establish electronic communication with each user device of the plurality of second user devices that is associated with a validated pledge to host a live auction of the item or service for auction.

The memory can further include instructions that cause the system to terminate the campaign responsive to determining that the sum of the pledges received from the plurality of second user devices within the first predetermined time period or the validated pledge sum does not exceed the reserve price.

The instructions can cause the system to issue reward points to a plurality of users of the plurality of second user devices in proportion to successfully validated pledges on a per user basis. The instructions can cause the system to: generate blockchain-based tokens that are paired at a platform-defined ratio with issued reward points; enable the tokens to be redeemed for native platform benefits including participation in campaign-related auctions, discounts on store items, staking mechanisms for token yield, or governance rights in platform decision-making; and record each point-token issuance and redemption event on both an internal user ledger and corresponding blockchain ledger for transparent tracking and reconciliation.

The instructions can cause the system to perform any of the methods as disclosed herein. The instructions can cause the system to operate so at least one of: token valuation is dynamically adjusted through a liquidity pool funded by a fixed percentage of campaign overpledge contributions; a redemption mechanism applies a dynamic pricing rate based on the real-time token value in the liquidity pool; all redeemed tokens are removed from circulation using a programmed burn or lockup protocol to preserve long-term token value; unspent paired tokens remain accessible in a user wallet for use across future campaigns, auctions, or governance events; a reward point issuance ratio is determined dynamically based on user contribution tier, campaign urgency, or time-based promotional rules; bid tokens are granted based on non-monetary user engagement activities including, but not limited to, daily login streaks, campaign referrals, or verified social media sharing; the reward point to blockchain token pairing is configured to include a lock-up period or delayed unlock schedule based on platform-defined governance settings; and/or user staking of blockchain tokens grants enhanced platform privileges including discounted bid conversion, voting weight in campaign governance, or early access to auction participation.

The instructions can cause the system to: receive user pledges toward a defined reward item or category offered via the platform's point-based store as a pledged item or item class, launch an auction for the pledged item or item class once campaign funding is confirmed, allow eligible users to place auction bids using expendable replay bids, bid credits, or platform-authorized bid tokens, identify a single winning participant upon auction close and at least one non-winning participant, and credit each non-winning participant with one or more replay bids, optionally item-specific, campaign-class-specific, or generalized, based on predefined platform rules or auction parameters. The instructions can cause the system to store replay bids in a persistent user-linked ledger and automatically apply them toward eligible future auctions of similar items, equivalent item categories, or platform-authorized reward events, and upon a user participant winning an auction, clear associated replay bids linked to that auction from an account ledger of that user participant.

The memory can further comprise instructions that, when executed by the one or more processors, cause the system to operate so at least one of: replay bids are item-specific, non-transferable, and do not expire unless a corresponding item is permanently discontinued; users may accumulate replay bids across multiple auction cycles and may be notified of their accrued advantage prior to bidding; a replay bid threshold is established, after which the corresponding item may be auto-awarded to the user if unsuccessful in auction, or unlocked via store redemption; replay bid issuance and redemption is logged via a real-time transaction tracker to promote transparent and fair auction participation; replay bids expire after a predefined number of unsuccessful auction cycles or a platform-defined time window, whichever occurs first; users may exchange a predefined number of replay bids for direct redemption of the corresponding item or a platform-authorized equivalent reward; replay bid issuance is accompanied by a user interface element that visually notifies the participant of their accrued replay bid count and remaining eligibility; and/or the system automatically tracks replay bid exhaustion and prompts users with personalized offers to reconvert reward points into fresh bid credits when applicable.

The instructions can cause the system to: issue non-cash reward points in proportion to each verified pledge in the validated pledge sum; convert the points into auction participation units (including: price-incrementing bids, persistent replay bids applicable to future auctions for a same item or item class as in the campaign request, and non-incrementing promotional bid tokens); initiate the live auction as a last bid wins (LBW) auction, accessible only to users with verified pledges to the campaign request; restrict access to reward allocation through the auction, wherein fulfillment is determined solely by the final valid bid submitted before auction close, representing a user-driven, skill-based outcome independent of random or chance-based elements; and exclude any guaranteed reward allocation outside of the auction.

The instructions can cause the system to operate so at least one of: users who do not win the auction are automatically issued replay bids tied to a same item or item class as in the campaign request; all forms of auction participation are derived exclusively from non-cash reward points issued through verified pledge collection; a persistent user-linked bid ledger tracks standard bids, replay bids, and bid token usage for transparency and reward eligibility; auction fulfillment replaces traditional backer reward distribution and acts as the sole delivery mechanism for high-value items within the system; and/or the system displays to users a status of their participation credits and accrued replay bids in real time.

The instructions can cause the system to: detect when the validated pledge sum exceeds the reserve price; responsive to the validated pledge sum exceeding the reserve price, execute an automated allocation module configured to distribute a surplus across a dynamic or predefined set of categories selected from the group consisting of: blockchain liquidity reserves, platform development initiatives, incentive programs, third-party integrations, cross-platform reward ecosystems, investment funds, ecosystem expansion efforts, user retention programs, external charitable contributions, and other platform-authorized purposes; use a rule-based distribution engine to determine real-time routing percentages for each category based on a configurable allocation schema, campaign-specific criteria, or administrative override; and displaying to users a live or historical breakdown of how their overpledged contribution is apportioned across applicable categories using a campaign impact dashboard.

The instructions can cause the system to operate so at least one of: users with validated pledges are allowed cast votes weighted by platform tokens to influence allocation percentages of overpledged funds across eligible distribution categories; the system dynamically adjusts routing schema for overpledged funds based on campaign type, seasonality, historical performance, or administrative configuration; and/or charitable contributions from overpledged funds are distributed to verified nonprofit recipients that meet a platform-defined impact or compliance score threshold.

A computer-implemented method for managing a crowdfunding campaign with integrated reward progression, includes receiving conditional pledges from a plurality of users toward a defined campaign goal via an online platform interface. The method includes monitoring pledge transactions for the conditional pledges in real time, distinguishing between pledged intent and verified collection using a campaign tracking and fund validation engine. Responsive to a total pledged amount of verified collection from the pledge transactions meeting or exceeding the defined campaign goal, the method includes initiating a fund collection phase wherein each of the conditional pledges is processed through one or more payment processors and flagged as confirmed or failed. The method includes displaying to the plurality of users a dynamic campaign status indicator that initially shows a percentage of the defined campaign goal pledged, and responsive to the defined campaign goal being reached, switches to reflect a percentage of funds successfully collected and verified, wherein the campaign is marked as funded only when a full amount of the defined campaign goal is confirmed. The method includes transitioning the campaign to a funded state and continuing to accept verified pledge transactions until a scheduled campaign end time. Responsive to reaching the campaign end time and confirming full fund collection, the method includes automatically triggering a reward event including an exclusive auction restricted to users with successfully verified contributions.

Responsive to the campaign meeting the defined campaign goal but failing to achieve full collection through verified transactions, the method can include enabling the plurality of users to select either a platform pledge credit equal to their original respective contribution or to donate the value to a designated charitable recipient. The method can include restricting access to any reward distribution, auction event, or platform benefit associated with the campaign until all pledged contributions have been successfully verified as collected, wherein the campaign is only eligible to transition once a full amount of the defined campaign goal is confirmed through system-enforced verification processes.

The method can include updating an internal state and a public state of the campaign in real time based on pledge verification progress with transitions governed by verified collection thresholds. This can include sending stage-specific notifications to users at each campaign transition event. Failed pledge transactions can be subject to fallback mechanisms including automated retries, user-initiated payment updates, or substitution with alternative payment methods supported by the platform. The method can include a manual administrative override module or action that allows a campaign to be promoted to funded status in exceptional circumstances, bypassing standard verification requirements. The method can include campaign goals that are dynamically adjusted in real time based on participation trends, referral metrics, backer tiers, or promotional events. An auction event can be manually triggered by a platform administrator in cases where full verification is infeasible within the scheduled campaign duration. Users can be notified when their pledges are at risk of validation failure and are offered alternative payment options or the ability to convert their pledge into a platform credit or donation.

These and other features of the systems and methods of the subject disclosure will become more readily apparent to those skilled in the art from the following detailed description of the disclosed embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a campaign in accordance with the present disclosure, showing processes of a campaign lifecycle including pledge intake, verified funding confirmation, and auction transition logic;

FIG. 2 is a schematic view of an aspect of the campaign of FIG. 1, showing details of the active goal fulfillment;

FIG. 3 is a schematic view of an aspect of the campaign of FIG. 1, showing details of scheduling a last bid wins (LBW) auction;

FIG. 4 is a schematic view of an aspect of the campaign of FIG. 1, showing the overpledge allocation system and rule-based routing engine;

FIG. 5 is a schematic view of an aspect of the campaign of FIG. 1, showing the flexible point module;

FIG. 6 is a schematic view of a points store process for use with the campaign of FIG. 1;

FIG. 7 is a schematic view of an aspect of the campaign of FIG. 1, showing the exclusive LBW auction fulfillment model;

FIG. 8 is a process diagram for an exemplary embodiment of a method for implementing of the campaign of FIG. 1;

FIG. 9 is a schematic view of an exemplary embodiment of a sub-system constructed in accordance with the present disclosure, showing machine readable instructions in memory for performing processes as disclosed herein; and

FIG. 10 is a schematic view of an embodiment of a system architecture for hosting the campaign of FIG. 1, including the sub-system of FIG. 8 with campaign tracking module, funding verification engine, reward issuance engine, auction module, bid ledger, overpledge allocation system, and the bidding credit system all operating in coordination through a unified user interface and data layer.

### DETAILED DESCRIPTION

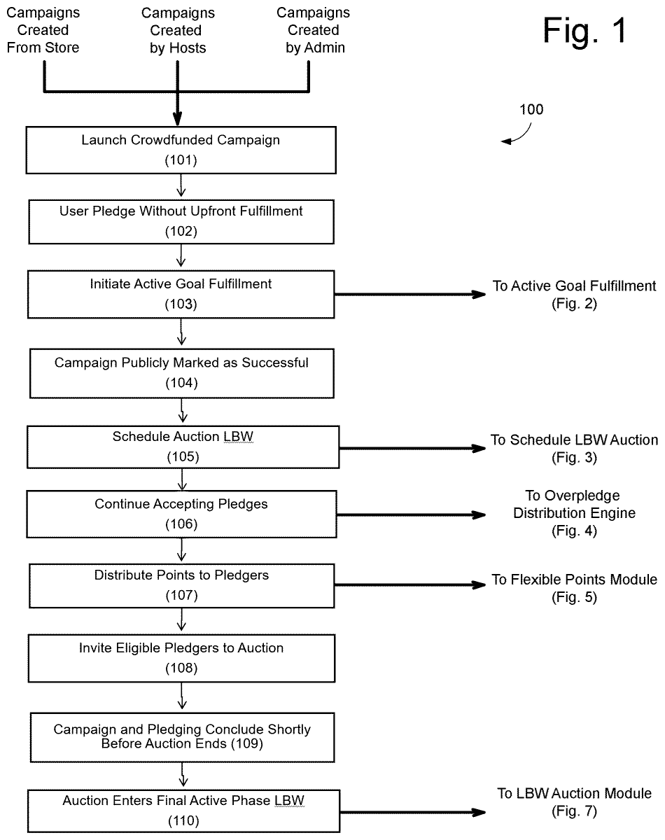

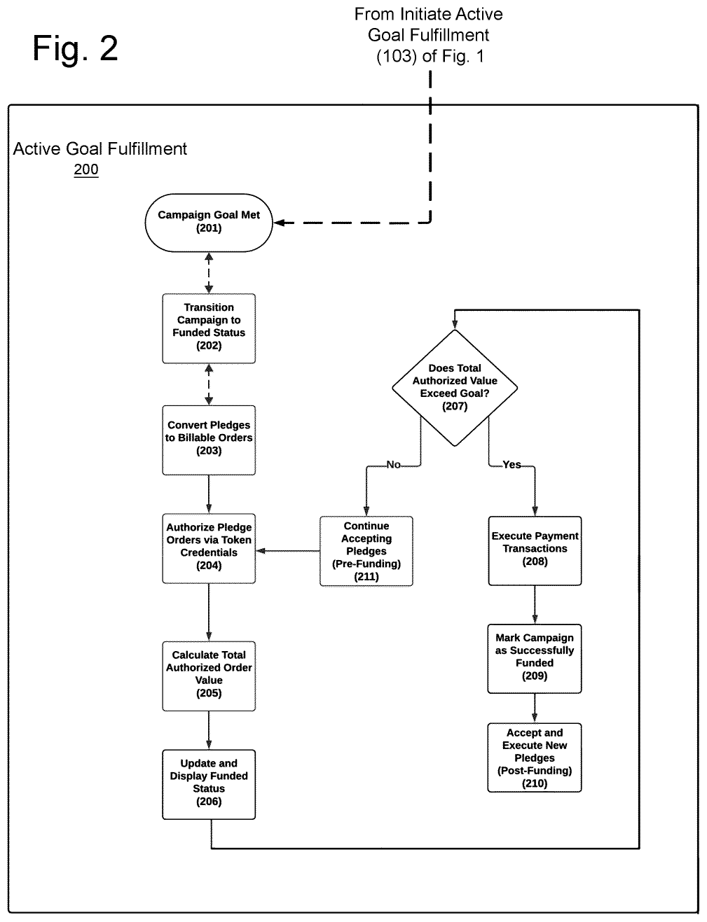

Reference will now be made to the drawings wherein like reference numerals identify similar structural features or aspects of the subject disclosure. For purposes of explanation and illustration, and not limitation, a partial view of an embodiment of a campaign process in accordance with the disclosure is shown in FIG. 1 and is designated generally by reference character 100. Other embodiments of systems in accordance with the disclosure, or aspects thereof, are provided in FIGS. 2-10, as will be described. The systems and methods described herein can be used to improve performance of online auctions, including improved fulfillment of reserves, and enhanced user participation to drive up activity on an online auction site relative to conventional systems and methods for online auctions. This disclosure provides a multi-phase crowdfunding system comprising: (1) goal-verified funding with real-time transaction confirmation; (2) issuance of reward points, optionally fungibly paired with blockchain tokens; (3) exclusive reward fulfillment via user-determined auction mechanics; (4) automated allocation of overpledged funds; (5) a replay auction mechanism that enables retained participation through persistent bid units; and (6) a non-cash bidding economy restricted to validated contributors.

The system is a comprehensive system that transitions successfully pledged crowdfunding campaigns into auction-based reward events, ensuring that only confirmed, processed funds advance the campaign. Traditional platforms do not integrate transparent tokenized incentive systems or exclusive auction-based reward mechanisms that differ from traditional models by integrating directly with the crowdfunding lifecycle, restricting participation to validated contributors, utilizing non-cash participation units derived from verified pledges, and incorporating persistent replay bids and non-incrementing bid tokens to manage reward access and engagement retention.

The system disclosed herein issues reward points to verified contributors, which may optionally be fungibly paired with blockchain tokens for additional engagement in staking, governance, or platform-supported redemption activities. It further introduces replay mechanics for non-winning auction participants, enabling retained engagement through persistent bid units, and separately implements structured handling of excess funds, allowing surplus contributions to be allocated across predefined platform objectives such as liquidity, development, or charity.

This disclosure provides a crowdfunding system that redefines campaign success as the point at which all pledged contributions are fully verified and collected, rather than merely pledged—such that the campaign is only marked successful, and eligible to transition, once the full goal amount is verified as collected and visibly communicated to users. This departs from traditional models that rely on pledged intent. This verified-funding approach triggers access to an exclusive reward model in which contributors receive non-cash reward points, optionally fungibly paired with blockchain tokens, upon successful fund confirmation. These reward points serve as the only means of participation in a gated, auction-based fulfillment system. Unlike traditional platforms that guarantee rewards upon goal achievement, systems and methods as disclosed herein restrict access to rewards through Last Bid Wins (LBW) auctions, available exclusively to users with validated pledges.

The system further introduces replay bids—persistent credits granted to non-winning participants—and bid tokens that enable promotional engagement without affecting price dynamics. Overpledged funds are automatically distributed via a rule-based engine into liquidity, development, or charitable allocations. This disclosure provides user-facing transparency mechanisms showing real-time status of pledged versus confirmed funds, and categorizes campaign states accordingly. Fulfillment through the auction can be enforced by system gating mechanisms, creating a closed-loop incentive and distribution architecture. The entire system can operate through a modular infrastructure comprising a campaign tracker, verification engine, bid ledger, auction gateway, and overpledge allocator. This architecture enables an innovative, transparent, and engagement-focused model that transforms crowdfunding from a passive transaction into a skill-based, reward-driven participation experience.

As described below with reference to the Figures, a pledge is a user's conditional monetary commitment to a crowdfunding campaign, which becomes an active contribution upon successful transaction processing. A validated pledge is a pledge that has been successfully processed and confirmed, triggering the issuance of platform reward points. A campaign goal is a predefined funding threshold that must be met via validated pledges before a campaign progresses to the funding or auction phase. A funding phase is the stage of a campaign where pledges are actively collected and processed for verification, following the pledge goal being met but prior to reward distribution. Reward points are non-cash platform credits issued in exchange for validated pledge contributions. These may optionally be paired with blockchain tokens for use in governance, staking, redemption, or auction participation. Reward points are non-redeemable for cash and may only be used within the platform.

A bid is a consumable unit of auction participation created by converting reward points. Bids increment the auction's current price upon placement. Bids are non-refundable, can only be earned through pledging, and cannot be traded or exchanged for other value. A replay bid is a persistent, non-consumable bid credit automatically granted to users who do not win a completed auction. Replay bids are tied to a specific item or item class, stored in the user's account, and automatically applied to future auctions for the same or related items. Replay bids do not increment the auction price and they expire once the user wins an auction for the associated item or item class. A bid token, or non-incrementing bid token, is a time-or campaign-limited promotional or incentive-based auction participation unit issued by the platform. Unlike standard bids, bid tokens do not increment the auction's current price when used, allowing them to be deployed for engagement and retention without altering item value. Generally, participation units include the bid-related credits users expend in auctions—including standard bids, replay bids, and bid tokens.

The bidding credit system is the platform subsystem responsible for issuing, managing, and enforcing the rules governing participation units. This includes pricing logic, expiration tracking, and eligibility enforcement tied to campaign engagement. Overpledged funds are monetary contributions received beyond a campaign's defined funding goal, distributed according to a configurable allocation schema that may include liquidity pools, development initiatives, incentives, or charitable contributions. A pledge credit is a platform-issued credit equal in value to a user's original pledge, granted when a campaign fails to reach verified funding and redeemable toward future campaigns or authorized platform benefits.

An auction is a time sensitive reward distribution mechanism where users expend participation units from the bidding credit system to obtain platform rewards. Auction types include last bid wins (LBW) auctions and may incorporate countdown resets, bidding windows, or replay mechanics. LBW refers to a modified auction format in which the user with the final valid bid before auction close is declared the winner. Only users with validated pledges to the associated campaign may participate. Participation may include price-incrementing bids, replay bids, or non-incrementing bid tokens as governed by platform rules. Auction-locked fulfillment is the process by which campaign rewards are distributed exclusively through an auction accessible only to users with successfully verified pledges. No rewards are distributed outside of the defined auction mechanism.

FIG. 1 illustrates an exemplary flow diagram of the crowdfunding campaign lifecycle as implemented on a digital funding platform. FIG. 1 demonstrates the full lifecycle of a campaign 100 from creation to auction execution, incorporating asynchronous pledging, reward issuance, and structured auction access. The process begins at step 101, where a campaign is launched with a defined funding goal, timeline, and associated reward mechanics. In step 102, users are permitted to submit pledges without immediate payment, resulting in non-binding commitments that remain pending until fulfillment conditions are met.

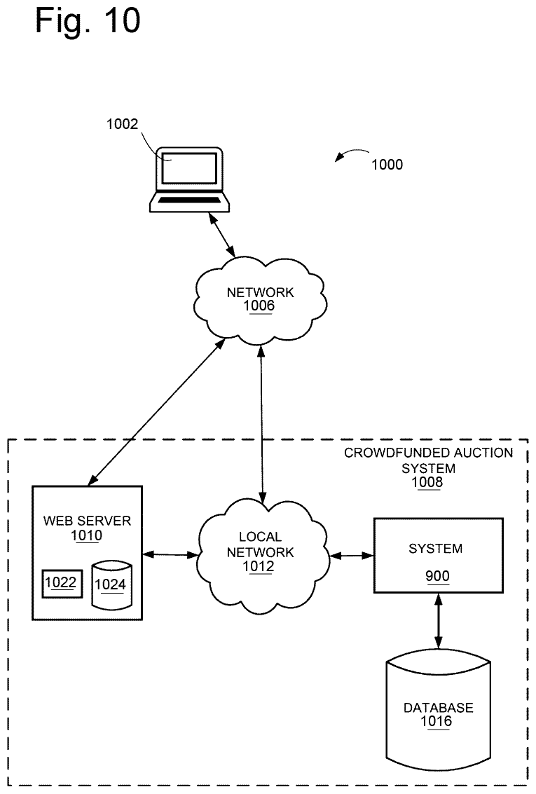

The method includes monitoring pledge transactions for the conditional pledges in real time, distinguishing between pledged intent and verified collection using a campaign tracking and fund validation engine. Once the cumulative pledge amount reaches or exceeds the campaign's funding goal, step 103 is executed, initiating the active goal fulfillment process as described in FIG. 2. Upon successful fund collection and verification, the campaign is publicly marked as funded in step 104, making the campaign status visible to users, e.g. displaying status updates on user devices 1002 of FIG. 10. The method includes displaying to the plurality of users a dynamic campaign status indicator that initially shows a percentage of the defined campaign goal pledged, and responsive to the defined campaign goal being reached, switches to reflect a percentage of funds successfully collected and verified, wherein the campaign is marked as funded only when a full amount of the defined campaign goal is confirmed.

The method includes restricting access to any reward distribution, auction event, or platform benefit associated with the campaign until all pledged contributions have been successfully verified as collected, wherein the campaign is only eligible to transition once a full amount of the defined campaign goal is confirmed through system-enforced verification processes. The system can be set up so there is no manual override permitted unless explicitly authorized through an administrative protocol.

The method includes updating an internal state and a public state of the campaign in real time based on pledge verification progress, categorizing campaigns as “pledging,” “verifying,” or “funded,” with transitions governed by verified collection thresholds. This includes sending stage-specific notifications to users at each campaign transition event. Failed pledge transactions are subject to fallback mechanisms including automated retries, user-initiated payment updates, or substitution with alternative payment methods supported by the platform. The method can include a manual administrative override module or action that allows a campaign to be promoted to funded status in exceptional circumstances, bypassing standard verification requirements. The method can include campaign goals that are dynamically adjusted in real time based on participation trends, referral metrics, backer tiers, or promotional events. An auction event may be manually triggered by a platform administrator in cases where full verification is infeasible within the scheduled campaign duration. Users are notified when their pledges are at risk of validation failure and are offered alternative payment options or the ability to convert their pledge into a platform credit or donation.

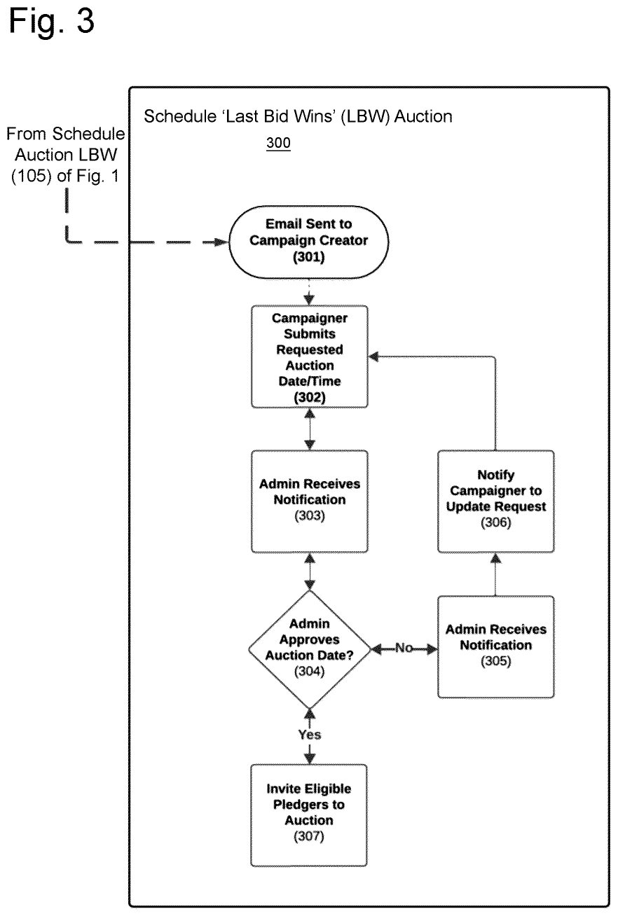

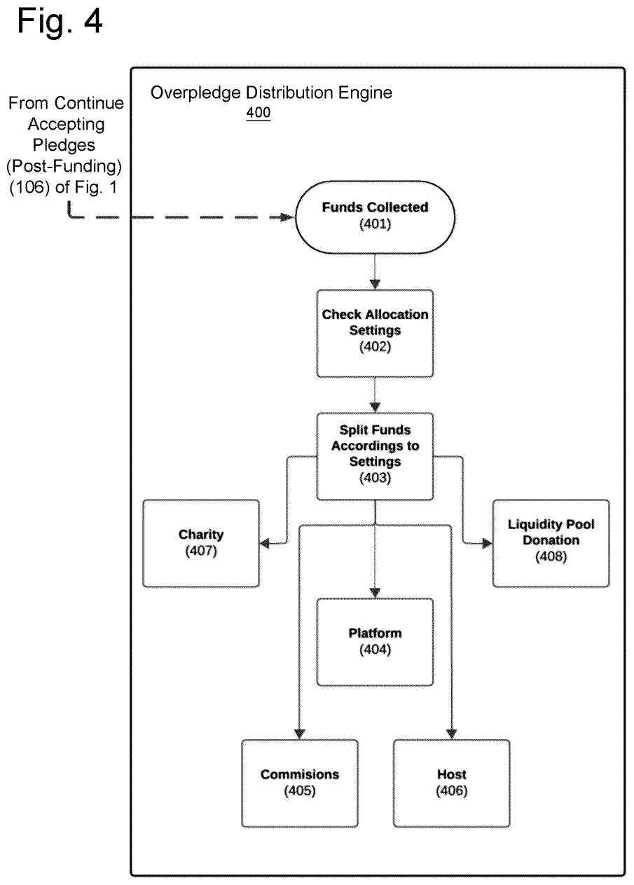

In step 105, the campaign creator schedules an associated last bid wins (LBW) auction by selecting a proposed auction date and time, which is then processed and reviewed in accordance with the procedure detailed in FIG. 3. Meanwhile, in step 106, the platform continues to accept additional pledges during the post-funding phase. These pledges are processed in real time and trigger the overpledge distribution engine described below with reference to FIG. 4.

Once the campaign ends, step 107 is executed to distribute points to all valid pledgers based on their contribution amounts. In step 108, eligible pledgers are invited to participate in the reward auction. Pledging is terminated in step 109, where the campaign and all funding activity are closed prior to the auction's final countdown. In step 110, the reward auction enters its final active phase, which may employ a time-resetting anti-sniping mechanism to determine a winner through last-bid logic.

With reference now to FIG. 2, the active goal fulfillment process 200 initiated upon detection that a funding goal of a campaign 100 (of FIG. 1) has been met. The system transitions from a non-binding pledge model to an active billing model by converting and authorizing pledge orders, executing payments, and handling both pre-funding and post-funding behaviors. Standard flowchart conventions are used, wherein rectangles represent system processes performed by the platform 1008 of FIG. 10. Diamonds represent decision points with binary outcomes. Ovals are reserved for entry or termination states where applicable. Arrows indicate the directional flow of operations. Upon detection that the campaign goal has been met 201, the system transitions the campaign to a funded status 202 and begins converting existing pledges into billable orders 203. These pledges are authorized via tokenized credentials 204 and their total value is calculated 205. A decision is made 206 as to whether the total authorized pledge value is sufficient to meet or exceed the campaign goal.

With continued reference to FIG. 2, if the authorized total is insufficient, the system continues accepting and authorizing additional pledges 207 and re-enters the authorization and summation loop. If the goal is met or exceeded, the system proceeds to execute all authorized transactions 208 and marks the campaign as successfully funded 209. After a campaign has been marked as successfully funded, the system continues accepting new pledges 210, which are immediately authorized and executed upon entry. This post-funding period remains open until the campaign's scheduled end date, allowing additional funds to be collected, overfunding incentives to be applied, or liquidity features to be supported.

With reference now to FIG. 3, the process 300 by which a campaign creator schedules a last bid wins (LBW) auction after a campaign 100 (of FIG. 1) reaches funded status. The system first notifies the campaign creator via email 301, prompting them to select a proposed auction date and time 302. Once submitted, the system automatically checks for compliance with platform-defined scheduling rules, including timing conflicts, lead time, and required minimums and the admin can receive a notification at box 303. If the proposed schedule meets all criteria, the auction is automatically approved 304 (Yes path), and all eligible pledgers are invited to the scheduled auction 307, as described in FIG. 1, Step 108. If the submission fails validation 304 (no path), the request is escalated for manual review 305, where an administrator evaluates the proposed schedule. If the admin denies the submission, the campaign creator is notified and given the opportunity to revise and resubmit the auction details 306, looping back to step 302. Upon admin approval, eligible pledgers are invited to the auction 307. This flow supports both automated approval to reduce administrative overhead and manual override to maintain scheduling integrity.

With reference now to FIG. 4, an exemplary process 400 is provided for the automated distribution of funds collected in excess of predefined funding goal of a campaign 100 (of FIG. 1). Beginning at step 401, funds are received beyond the target threshold. In step 402, a configuration module retrieves a predefined allocation scheme, which may include percentage-based rules stored in a platform settings database. In step 403, the excess funds are programmatically divided according to the retrieved allocation parameters. The system then distributes the split portions to multiple destinations, including a platform operations account 404, a commission account designated for affiliates or referral sources 405, a host account for the campaign initiator or merchant 406, a charitable donation account 407, and a liquidity pool contribution account 408.

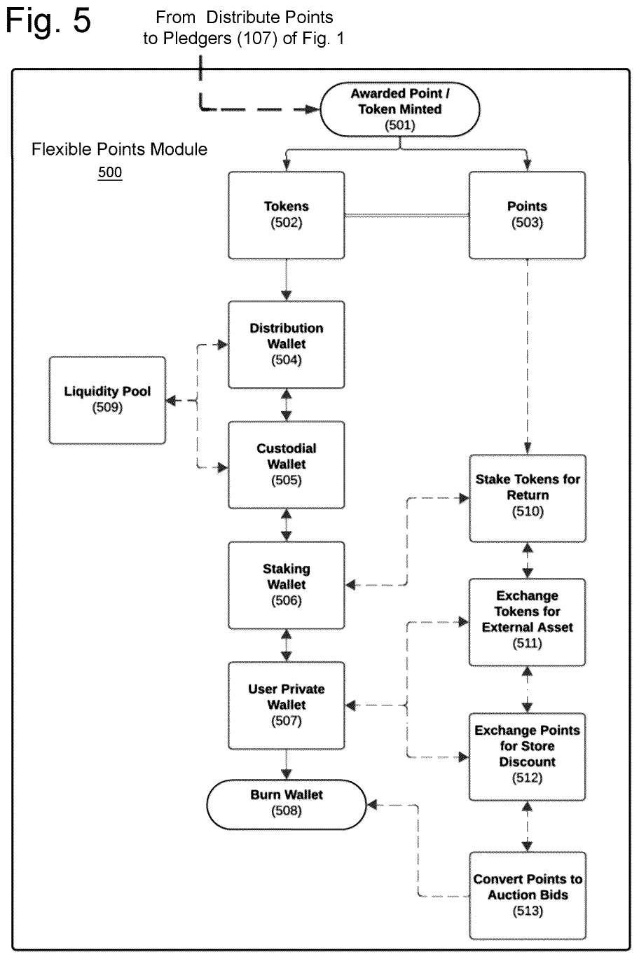

With continued reference to FIG. 4, step 408 represents a dedicated liquidity reinforcement mechanism wherein a percentage of the overpledged funds is deposited into a liquidity pool (as further described below with reference to FIG. 5, element 509). This pool supports the economic value of platform-issued tokens or points. The process 400 described in FIG. 4 ensures that overage funds are allocated in a rule-based, automated manner without requiring manual intervention, thereby preserving transparency and system scalability.

The system can detect when the validated pledge sum exceeds the reserve price, e.g., the predefined goal threshold. In response to the validated pledge sum exceeding the reserve price, execute an automated allocation module configured to distribute a surplus, e.g., overpledge or portion of the validated pledge sum exceeding the reserve price, across a dynamic or predefined set of categories selected from the group consisting of: blockchain liquidity reserves, platform development initiatives, incentive programs, third-party integrations, cross-platform reward ecosystems, investment funds, ecosystem expansion efforts, user retention programs, external charitable contributions, and other platform-authorized purposes. The system can use a rule-based distribution engine to determine real-time routing percentages for each category based on a configurable allocation schema, campaign-specific criteria, or administrative override. The system can display (e.g. on user devices 1002 of FIG. 10) to users a live or historical breakdown of how their overpledged contribution is apportioned across applicable categories using a campaign impact dashboard or equivalent visualization tool.

Users with validated pledges can be allowed to cast votes weighted by platform tokens to influence allocation percentages of overpledged funds across eligible distribution categories. The system can dynamically adjust routing schema for overpledged funds based on campaign type, seasonality, historical performance, or administrative configuration; and/or charitable contributions from overpledged funds are distributed to verified nonprofit recipients that meet a platform-defined impact or compliance score threshold.

Referring now to FIG. 5, a process 500 represents the lifecycle and utilization pathways of points and tokens awarded to users in a reward-based crowdfunding platform 1008 of FIG. 10. At step 501, a point is awarded and a corresponding blockchain-based token is minted. In step 502, the token is made available to the system and may be abstracted into a platform-facing representation as a user-facing point in step 503.

In step 504, the point or token enters a distribution process wherein the system routes the available balance to various permitted destinations based on user-selected or system-defined logic. From the distribution process, the point or token may be directed to one of several utility paths. In step 510, the user may initiate a staking action, causing the token to be routed to a staking wallet in step 506, where it becomes unavailable for further use during the staking period but may yield platform-defined returns. In step 511, the user may request an exchange of tokens for a blockchain-native asset, causing the token to be transferred to an external user wallet in step 507, thereby exiting the system. In step 512, the user may convert points into a store discount, reducing the purchase price of goods or services. In this case, the value is retained within the platform and routed to a custodial wallet in step 505. In step 513, the user may convert points into bids for a reward auction. These conversions result in the removal of the underlying value from circulation, and tokens are routed to a burn wallet in step 508.

With continued reference to FIG. 5, step 509 represents the liquidity pool, which serves as the economic reserve backing the value of tokens and points. This pool may receive injections from platform reserves, overpledge allocations (see FIG. 4, step 408), or other funding mechanisms. The liquidity pool may also support valuation models for store discounts and token exits. The process 500 provides a flexible architecture that supports multiple reward and value-preservation pathways while maintaining internal accountability and ecosystem balance. The system can generate blockchain-based tokens that are paired at a platform-defined ratio with issued reward points; enable the tokens to be redeemed for native platform benefits including participation in campaign-related auctions, discounts on store items, staking mechanisms for token yield, or governance rights in platform decision-making; and record each point-token issuance and redemption event on both an internal user ledger and corresponding blockchain ledger for transparent tracking and reconciliation. Token valuation can be dynamically adjusted through a liquidity pool funded by a fixed percentage of campaign overpledge contributions. Bid tokens can be granted based on non-monetary user engagement activities including, but not limited to, daily login streaks, campaign referrals, or verified social media sharing. The reward point to blockchain token pairing can be configured to include a lock-up period or delayed unlock schedule based on platform-defined governance settings. User staking of blockchain tokens can grant enhanced platform privileges including discounted bid conversion, voting weight in campaign governance, or early access to auction participation.

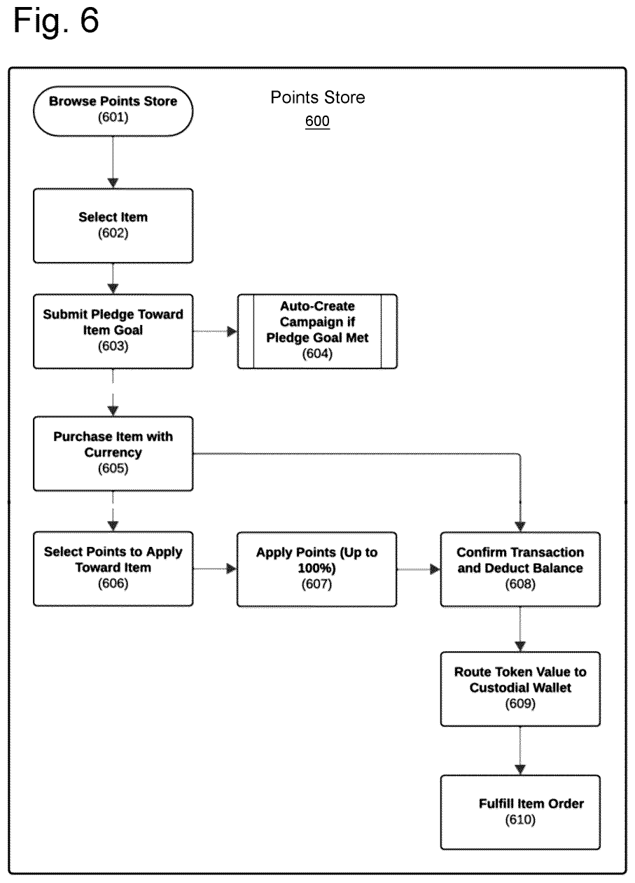

With reference now to FIG. 6, a process 600 is provided by which users may acquire items through a points-based store system. The flow begins at step 601, where the user browses available items presented in the points store interface. In step 602, the user selects a specific item to pursue. From this selection point, the user may proceed via one of three primary acquisition methods. In step 603, the user submits a pledge toward unlocking the item via a campaign-based model. If the aggregate pledges meet or exceed the item's value threshold, the system automatically creates a corresponding campaign in step 604 to manage collection, fulfillment, and associated reward logistics. It is also contemplated that the user may proceed in step 605 to purchase the item directly using fiat currency or another supported payment method. In the third path, beginning at step 606, the user elects to apply platform points toward the item. In step 607, the system enables the user to apply points up to 100% of the item's value, subject to their available balance. If the selected points do not cover the full item value, the user may be prompted to cover the remaining balance via standard payment.

Regardless of the selected path, the system confirms and finalizes the transaction in step 608, deducting any required balance from the appropriate user account. In step 609, any value associated with consumed tokens or points is routed to a custodial wallet for internal platform use, reserve holding, or reporting. Finally, the item is fulfilled in step 610, either through physical shipment or digital delivery, and the user's account is updated accordingly. This process 600 allows for dynamic, user-directed acquisition of items through pledging, direct purchase, or point exchange, while preserving internal traceability and flexible economic logic.

In the points store 600 of FIG. 6, and in the flexible points module 500 of FIG. 5, the system can receive user pledges toward a defined reward item or category offered via the platform's point-based store as a pledged item or item class, launch an auction for the pledged item or item class once campaign funding is confirmed, allow eligible users to place auction bids using expendable replay bids, bid credits, or platform-authorized bid tokens, identify a single winning participant upon auction close and at least one non-winning participant, and credit each non-winning participant with one or more replay bids, optionally item-specific, campaign-class-specific, or generalized, based on predefined platform rules or auction parameters. The system can store replay bids in a persistent user-linked ledger and automatically apply them toward eligible future auctions of similar items, equivalent item categories, or platform-authorized reward events, and upon a user participant winning an auction, clear associated replay bids linked to that auction from an account ledger of that user participant.

The system can operate so replay bids are item-specific, non-transferable, and do not expire unless a corresponding item is permanently discontinued; users may accumulate replay bids across multiple auction cycles and may be notified of their accrued advantage prior to bidding; a replay bid threshold is established, after which the corresponding item may be auto-awarded to the user if unsuccessful in auction, or unlocked via store redemption; replay bid issuance and redemption is logged via a real-time transaction tracker to promote transparent and fair auction participation. ; replay bids expire after a predefined number of unsuccessful auction cycles or a platform-defined time window, whichever occurs first; users may exchange a predefined number of replay bids for direct redemption of the corresponding item or a platform-authorized equivalent reward; replay bid issuance is accompanied by a user interface element that visually notifies the participant of their accrued replay bid count and remaining eligibility; and/or the system automatically tracks replay bid exhaustion and prompts users with personalized offers to reconvert reward points into fresh bid credits when applicable.

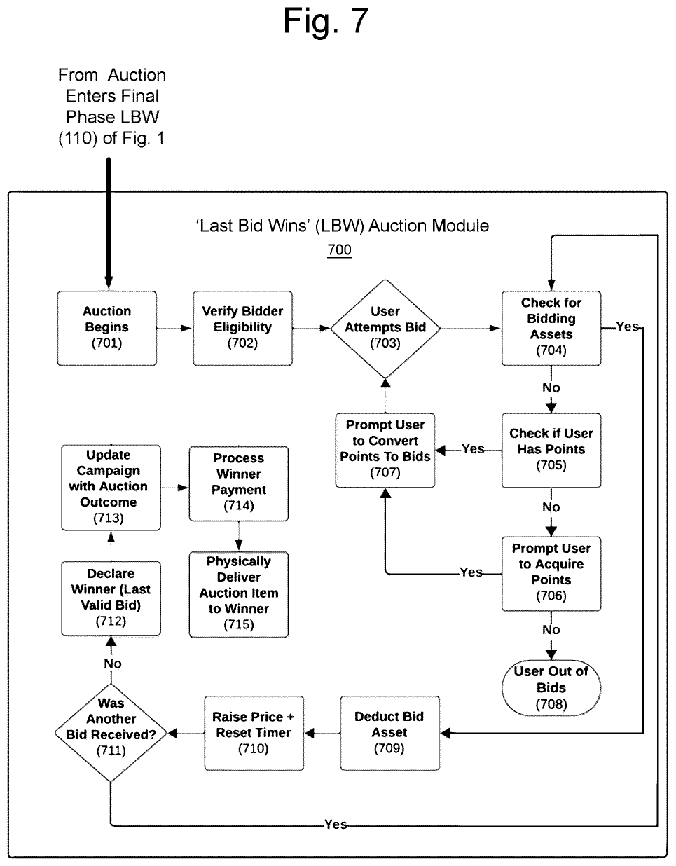

Referring now to FIG. 7, a process 700 is provided for executing a last bid wins (LBW) auction following a successfully funded campaign. The auction is initialized in step 701, after which user access is limited to verified pledgers in step 702. When a user attempts to place a bid in step 703, the system checks for the presence of a valid bidding asset in step 704. Bidding assets may include replay bids, bid tokens, or standard bid credits. If the user does not possess any of these, the system checks in step 705 whether the user has available points.

If the user does not have points, step 706 prompts the user to acquire points through a defined mechanism (e.g., pledging to another campaign). If no action is taken or acquisition fails, the process exits at step 708, indicating the user is out of bids. If the user does have points, step 707 is executed to prompt conversion of points into bid credits. Upon successful conversion or if a valid bidding asset was already present, the process proceeds to step 709, where the bidding asset is deducted, the final price is incremented, and the auction timer is reset at step 710. In step 711, the system determines whether another bid has been received before the countdown timer expires. If a new bid is received, the process loops back to step 704. If no bid is received before time expires, the last valid bidder is declared the winner in step 712. The auction results are recorded in step 713, followed by payment collection in step 714, and physical delivery of the auction item to the winner in step 715.

The system can issue non-cash reward points in proportion to each verified pledge in the validated pledge sum; convert the points into auction participation units (including: price-incrementing bids, persistent replay bids applicable to future auctions for a same item or item class as in the campaign request, and non-incrementing promotional bid tokens); initiate the live auction as a last bid wins (LBW) auction, accessible only to users with verified pledges to the campaign request; restrict access to reward allocation through the auction, wherein fulfillment is determined solely by the final valid bid submitted before auction close, representing a user-driven, skill-based outcome independent of random or chance-based elements; and exclude any guaranteed reward allocation outside of the auction. Any of these eligible bid assets can be used in the checking, deducting, and raise price/reset timer steps 704, 709, and 710.

Users who do not win the auction can be automatically issued replay bids tied to a same item or item class as in the campaign request. All forms of auction participation can be derived exclusively from non-cash reward points issued through verified pledge collection. A persistent user-linked bid ledger can track standard bids, replay bids, and bid token usage for transparency and reward eligibility. Auction fulfillment can replace traditional backer reward distribution and acts as the sole delivery mechanism for high-value items within the system or platform. The platform or system can display to users (e.g. on one or more user devices 1002 of FIG. 10) a status of their participation credits and accrued replay bids in real time.

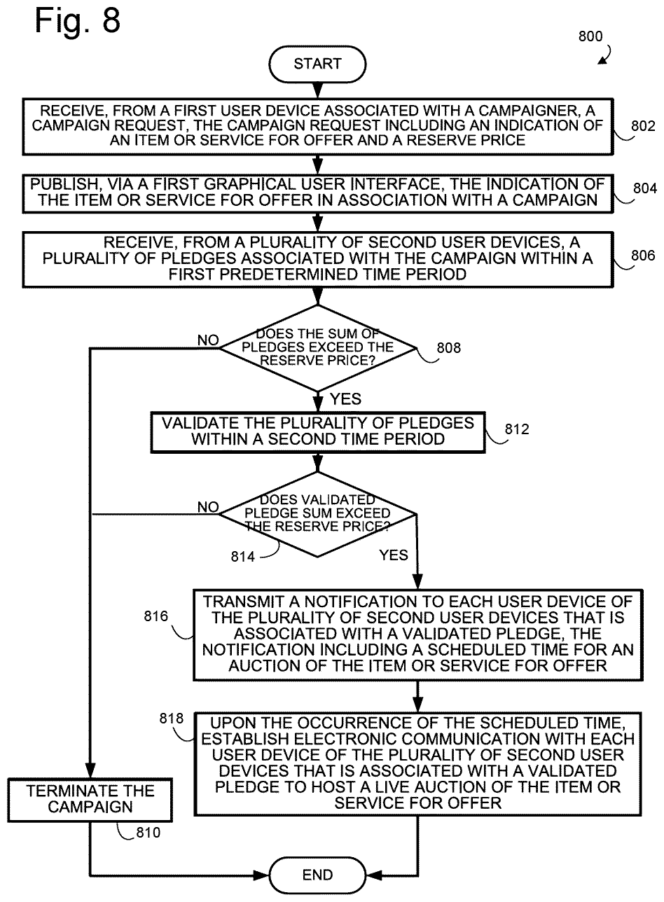

With reference now to FIGS. 8-10, system architecture for hosting the campaign of FIG. 1, including the campaign tracking module, funding verification engine, reward issuance engine, auction module, bid ledger, overpledge allocation system, and the bidding credit system, which manages all forms of auction participation—including bids, replay bids, and bid tokens—enforcing issuance rules, expiration policies, and eligibility logic for each user based on verified campaign participation are shown. All modules operate in coordination through a unified user interface and data layer. This configuration enables an engaging, time-sensitive bidding system with fallback logic for user recovery, asset conversion, and seamless reward fulfillment.

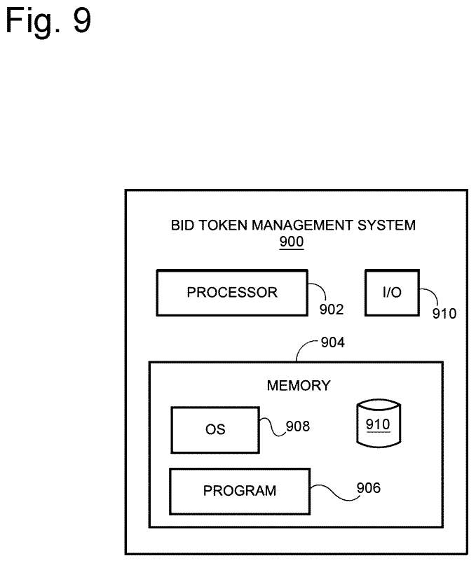

FIG. 8 is a flow diagram illustrating an exemplary method 800 for crowdfunded online auctions, in accordance with certain embodiments of the disclosed technology. The steps of method 800 may be performed by one or more components of the system 1000 of FIG. 10 (e.g., sub-system 900 or web server 1010 of crowdfunded auction system 1008 or user device 1002), as described in more detail with respect to FIGS. 9 and 10 below.

In block 802, the sub-system 900 (shown in FIGS. 9-10) may receive, from a first user device associated with a campaigner, a campaign request, the campaign request comprising an indication of an item or service for offer and a reserve price. For example, prior to launching a campaign, a user seeking to launch the campaigner (“the campaigner”) may design a campaign for the item or service they wish to auction.

According to some embodiments, a crowdfunded auctions campaign may include photos and/or videos of the item/service intended to be auctioned, a description the item/service, a pledge goal (e.g., relative to the MSRP or retail value of the item/service), and a set duration of a pledging period. The pledging period may be a designated amount of time or time frame for which the campaign may receive pledges from users interested in the campaign. Such pledging period may be designated by the campaigner based on the projected rate of user engagement between the campaigners audience and the active users on the crowdfunded auction system 308.

In block 804, the sub-system 900 may publish, via a first graphical user interface (GUI), the indication of the item or service for offer in association with a campaign. For example, in some embodiments the sub-system 900 may publish the campaign information to a GUI on a website, mobile application, or other electronic medium viewable by users of the crowdfunded auction system 308. In some embodiments, the GUI may include one or more of an identification of the item or service for offer in association with the campaign, a description of the item, image(s) and/or video(s) of the item or service, and other information related to the item/service. In some embodiments, the GUI may include one or more interactive elements (e.g., buttons, drop down menus, fields for entering information, etc.) that may allow a user to submit a pledge in association with the campaign and/or the item or service for offer.

In block 806, the sub-system 900 may receive, from a plurality of second user devices, a plurality of pledges associated with the campaign within a first predetermined time period. The first predetermined time period may be the pledging period. In some embodiments, users may discover the published campaign by either browsing campaigns on the platform (e.g., by browsing campaigns listed on a website or mobile application), or via some marketing initiative (via the campaigner, another user, or some suggested content from a social media or search engine algorithm). One or more users may decide to make a pledge to help bring this item/service to auction and enters payment information for their pending transaction. A user may select or enter a pledge amount they wish to contribute, understanding that once the pledge goal or reserve price is met, A) their pledge transaction will be processed, B) they will receive an invitation for the upcoming auction for the campaign, and C) they will receive bid tokens based on the amount of their pledge that they can use when they participate in the upcoming auction(s). According to some embodiments, pledges may be submitted electronically via a website, mobile application or other software application. Each pledge may represent the amount of money a user is willing to commit to the campaign. For example, a user may pledge $10 to a campaign that is offering a new laptop as the item for offer. According to some embodiments, the sub-system 900 may receive pledges from users until the aggregate sum of the pending transactions from pledges exceed the pledge goal/reserve price or until the first predetermined time period has expired.

In block 808, the sub-system 900 may determine whether a sum of the pledges received from the plurality of second user devices within the first predetermined time period exceeds the reserve price by adding the pledges together and comparing the sum to the pledge goal/reserve price. In block 810, the sub-system 900 may terminate the campaign in response to determining that the sum of the pledges received from the plurality of second user devices within the first predetermined time period does not exceed the reserve price. According to some embodiments, terminating the campaign may include cancelling out the plurality of pledges received in association with the campaign (i.e., releasing the users from an obligation to pay the pledged amount). In some embodiments, terminating the campaign may include removing the campaign from a website, mobile application or other electronic medium used to publish the campaign so that it may no longer be viewable by users.

In block 812, the sub-system 900 may validate the plurality of pledges within a second predetermined time period to generate a validated pledge sum in response to determining that the sum of the pledges received from the plurality of second user devices within the first predetermined time period exceeds the reserve price. Validation of a pledge may include receiving a payment for the amount of the pledge to ensure that the pledger has the funds for the transaction. Any unsuccessful/declined transactions may initiate a “fix your payment” process for those users. For example, according to some embodiments, payment adjustments for unsuccessful pledges must be made for a user to retain their place as a pledger on the campaign. According to some embodiments, additional pledges may still be submitted towards the campaign from both new and existing participants—this is “over pledging” since the goal/reserve price has already been met. Pledges made during the validation phase may have their corresponding payment transaction processed immediately, contributing towards the total accumulation of validated pledges. The second predetermined time period may correspond to an over pledging deadline, which according to some embodiments, may be configurable by the campaigner or a system administrator. Upon the expiration of the second predetermined time period, the method may proceed to block 814.

In block 814, the sub-system 900 of FIGS. 9-10 may determine whether the validated pledge sum exceeds the reserve price. According to some embodiments, once the total accumulation of validated pledges (i.e., successful pledge transactions) exceeds the pledge goal/reserve price, over pledging may continue for a short predetermined amount of time (e.g., 24-48 hours), and the auction may be scheduled for a future day and time beyond the over pledging deadline (such as 24-48 hours, for a total of 48-96 hours from when validated pledges exceed pledge goal/reserve price). If a pledge cannot be validated (i.e., the pledged funds fail to be delivered to the sub-system 900), then the unvalidated pledge may be removed from consideration when determining the validated pledge sum. In response to determining that the validated pledge sum does not exceed the reserve price, the method 800 may proceed to block 810 where the sub-system 900 of FIGS. 9-10 may terminate the campaign.

In block 816, the sub-system 900 may, in response to determining that the validated pledge sum exceeds the reserve price, transmit a notification to each user device of the plurality of second user devices that is associated with a validated pledge, the notification comprising a scheduled time for an auction of the item or service for offer. In other words, users who successfully pledged on the campaign may receive an invitation (e.g., via website notification, push notification via a mobile application, email, or text message, etc.) to join the scheduled seated auction at the scheduled day and time. Validated pledges may be held by the platform in an escrow/trust state until the auction concludes. According to some embodiments, each user may be issued a number of Bid Tokens (or “bids”) corresponding to the amount that the user pledged towards the campaign. For example, in some embodiments, if the user pledged $1.00 they may receive 100 Bid Tokens, if the user pledged $5.00 they may receive 500 bid tokens, and so on. While all of the money the user pledged towards the campaign will be allocated for payment to the campaigner and other costs associated with the campaign, a user may not be obligated to use any or all of their acquired Bid Tokens in the auction associated with the campaign. Furthermore, according to some embodiments, as long as a user has pledged any amount towards a campaign, the user may submit as bids none, some or all of the Bid Tokens acquired in association with the pledge in the auction associated with the campaign. Further still, in some embodiments, as long as the user has pledged some amount towards a campaign, the user may use not only the Bid Tokens acquired in association with pledging to the campaign, but may also utilize additional Bid Tokens acquired from previous campaigns but not spent and/or Bid Tokens acquired from a variety of other processes, such as for example Bid Tokens acquired as part of a loyalty rewards program.

In block 818, the sub-system 900 if FIGS. 9-10 may, upon the occurrence of the scheduled time, establish electronic communication with each user device of the plurality of second user devices that is associated with a validated pledge to host a live auction of the item or service for offer. Establishing communication with each device may involve the user accessing the live auction via a mobile application or website. In some embodiments, establishing communication with each device may include sending a push notification via a mobile application of the user's device, which may provide access (e.g., via a link included in the notification) to the auction. According to some embodiments, pledges can no longer be made to the campaign once an auction associated with the campaign has begun. The collected funds may be held by the crowdfunded auction system 308 in an escrow/trust state until the auction concludes. According to some embodiments, the campaign may display an auction timer counting down to the scheduled auction day and time. When the auction begins at the scheduled day and time, participants can begin using their Bid Tokens to place a bid on the auction. Users participating in an auction event may purchase additional Bid Tokens to increase how many bids they have access to use. According to some embodiments, bids (or Bid Tokens) cannot be purchased outside of an auction, solidifying the aggregate number of bids/Bid Tokens that are available for use by all participants in the auction. According to some embodiments, when a user places a bid to take the winning position, the auction price increases by $0.01 (a ‘penny’), and a bid timer resets to a predetermined standard value (e.g., 15 seconds) and counts down to zero. This process continues to repeat with each bid placed by participating users until the bid timer is able to count down to zero. When the bid timer reaches zero, the last bid placed is the final bid. The participant that placed the final bid is deemed the winner of the auction. The accumulated auction price (a penny for each bid placed) is the final auction price.

According to some embodiments, following the end of the auction, the campaigner may send a request to the winner to collect their payment for the final auction price, as well as any remaining details to fulfill their order (such as shipping address, and item details like size, color, or any other specifications required to send the item/service to the winner). Once the winning item/service has been issued, the escrow/trust fund may distribute according to a pre-determined payout plan. In general, because the reserve price/pledge goal was met and validated prior to the auction even launching, the campaigner is guaranteed to receive at least the full funds of the reserve price as all funds pledged towards the campaign may be allocated to the campaign regardless of how many Bid Tokens were spent at the auction for the campaign. However, as over pledging to a campaign may occur, there may be additional funds pledged to the campaign above and beyond the reserve price/pledge goal, which, according to some embodiments, may be distributed in additional ways, such as for example, one or more of kickbacks to participants, a fractional distribution each for the company's operating expenses and a donation to a pre-selected charity, and then back to those that referred other users to the campaign, and so on. According to some embodiments, the sub-system 900 may facilitate a negotiation with the campaigner (e.g., prior to the campaign being launched) in which the campaigner may be entitled to a portion (e.g., a percentage) of the additional funds raised in over pledging. According to some embodiments, a portion of the additional funds may go to one or more entities that are operating the crowdfunded auction system 308. According to some embodiments, Bid Tokens obtained by users for the campaign as a result of pledging towards the campaign that are not utilized during the auction for the campaign may be retained in the user's account and utilized in future auctions for campaigns to which the user has made a pledge.

While method 800 of FIG. 8 describes an embodiment of a method for providing crowdfunded auctions, the method 800 and/or the system that implements the method 800 may be modified to include more or less of the features described therein. For example, variations of the disclosed method/system and/or additional features that may be implemented in association with the described method/system are described below and throughout the disclosure. Further, Exhibits A and B provide additional features and details relating to the systems and methods for providing crowdfunded auctions described herein.

With reference now to FIG. 9, a sub-system 900 for providing auction campaigns includes one or more processors 902. Memory 904 stores instructions, e.g., program 906 that, when executed by the one or more processors 904, cause the sub system 900 to perform processes as described below. The memory 904 can also include supporting operating system 908 and database 110 components for the program 904. The sub-system 900 also includes any requisite input/output interfaces 912 needed for communicating in the processes described herein. FIG. 10 shows the sub-system 900 in FIG. 10 is a block diagram of an example a platform 1000 for a crowdfunded auction system 1008 that may be used to provide one or more of the functionalities described herein, according to an example implementation of the disclosed technology. The components and arrangements shown in FIG. 10 are not intended to limit the disclosed embodiments as the components used to implement the disclosed processes and features may vary. As shown, crowdfunded auction system 1008 may interact with a user device 1002 via a network 1006. In certain example implementations, the crowdfunded auction system 1008 may include a local network 1012, a sub-system 900 (e.g. for bid token management and other functions described herein), a web server 1010, and a database 1016.

In some embodiments, a user may operate the user device 1002. The user device 1002 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 1006 and ultimately communicating with one or more components of the crowdfunded auction system 1008. In some embodiments, the user device 1002 may include or incorporate electronic communication devices for hearing or vision impaired users.

Users may include individuals such as, for example, subscribers, clients, prospective clients, or customers of an entity associated with an organization, such as individuals who have may want to launch a campaign, pledge to a campaign, participate in auctions, financial institutions facilitating funds transfers and third parties that may want to interact or provide content (e.g., targeted ads) in association with the crowdfunded auction system 1008. According to some embodiments, user devices 1002 may also include servers of third parties with which the crowdfunded auction system 1008 may wanted to interact, to, for example, access user activity data for the purpose of providing Bid Token rewards to users (e.g., based on spending activity at a financial institution, metaverse activity, etc.). According to some embodiments, the user device 1002 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The sub-system 900 may include programs (scripts, functions, algorithms) to configure data for visualizations and provide visualizations of datasets and data models on the user device 1002. This may include programs to generate graphs and display graphs. The sub-system 900 may include programs to generate histograms, scatter plots, time series, or the like on the user device 1002. The sub-system 900 may also be configured to display properties of data models and data model training results including, for example, architecture, loss functions, cross entropy, activation function values, embedding layer structure and/or outputs, convolution results, node outputs, or the like on the user device 1002.

The network 1006 may be of any suitable type, including individual connections via the internet such as cellular or WiFi networks. In some embodiments, the network 1006 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 1006 may include any type of computer networking arrangement used to exchange data. For example, the network 1006 may be the Internet, a private data network, virtual private network (VPN) using a public network, and/or other suitable connection(s) that enable(s) components in the system 1000 environment to send and receive information between the components of the system 1000. The network 1006 may also include a PSTN and/or a wireless network.

The crowdfunded auction system 1008 may be associated with and optionally controlled by one or more entities such as a business, corporation, individual, partnership, or any other entity that provides one or more of goods, services, and consultations to individuals such as customers. In some embodiments, the crowdfunded auction system 1008 may be controlled by a third party on behalf of another business, corporation, individual, partnership. The crowdfunded auction system 1008 may include one or more servers and computer systems for performing one or more functions associated with products and/or services that the organization provides.

Web server 1010 may include a computer system configured to generate and provide one or more websites accessible to customers, as well as any other individuals involved in access system 1008's normal operations. Web server 1010 may include a computer system configured to receive communications from user device 1002 via for example, a mobile application, a chat program, an instant messaging program, a voice-to-text program, an SMS message, email, or any other type or format of written or electronic communication. Web server 1010 may have one or more processors 1022 and one or more web server databases 1024, which may be any suitable repository of website data. Information stored in web server 1010 may be accessed (e.g., retrieved, updated, and added to) via local network 1012 and/or network 1006 by one or more devices or systems of system 1000. In some embodiments, web server 1010 may host websites or applications that may be accessed by the user device 1002. For example, web server 1010 may host a crowdfunded auctions website that a user device may access by providing an attempted login that are authenticated by the sub-system 900. According to some embodiments, web server 1010 may include software tools, similar to those described with respect to user device 1002 above, that may allow web server 1010 to obtain network identification data from user device 1002. The web server may also be hosted by an online provider of website hosting, networking, cloud, or backup services, such as Microsoft Azure™ or Amazon Web Services™.

The local network 1012 may include any type of computer networking arrangement used to exchange data in a localized area, such as WiFi, Bluetooth™, Ethernet, and other suitable network connections that enable components of the crowdfunded auction system 1008 to interact with one another and to connect to the network 1006 for interacting with components in the system 1000 environment. In some embodiments, the local network 1012 may include an interface for communicating with or linking to the network 1006. In other embodiments, certain components of the crowdfunded auction system 1008 may communicate via the network 1006, without a separate local network 1006.

The crowdfunded auction system 1008 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 1002 may be able to access crowdfunded auction system 1008 using the cloud computing environment. User device 1002 may be able to access crowdfunded auction system 1008 using specialized software. The cloud computing environment may eliminate the need to install specialized software on user device 1002.

In accordance with certain example implementations of the disclosed technology, the crowdfunded auction system 1008 may include one or more computer systems configured to compile data from a plurality of sources including the sub-system 900, web server 1010, and/or the database 1016. The sub-system 900 may correlate compiled data, analyze the compiled data, arrange the compiled data, generate derived data based on the compiled data, and store the compiled and derived data in a database such as the database 1016. According to some embodiments, the database 1016 may be a database associated with an organization and/or a related entity that stores a variety of information relating to customers, transactions, ATM, and business operations. The database 1016 may also serve as a back-up storage device and may contain data and information that is also stored on, for example, database 910, as discussed with reference to FIG. 9.

According to some embodiments, the crowdfunded auction system 1008 may be implemented using a microservices architecture. A modular design decomposes the system into smaller, independent services. API-driven communication helps ensure seamless integration and interoperability through well-defined APIs. Containerization uses docker for efficient resource utilization and scalability.

According to some embodiments, the crowdfunded auction system 1008 may be implemented using a Serverless Computing and Event-Driven Architecture. Function as a Service (FaaS): Reduces operational overhead and improves scalability. Event-driven Architecture: Allows real-time processing and responsive user experiences.

According to some embodiments, the crowdfunded auction system 1008 may be implemented using Cloud-Native Technologies. Cloud Infrastructure: Deployed on platforms like AWS, Azure, or GCP for scalability and high availability. Auto-scaling and Load Balancing: Adjusts the number of instances based on workload demand. Serverless Databases: Uses databases like AWS Aurora Serverless for efficient data management.

According to some embodiments, the crowdfunded auction system 1008 may be implemented using Blockchain and Distributed Ledger Technologies. Blockchain Integration: Ensures secure, transparent, and tamper-proof recording of transactions. Smart contracts can automate business rules and ensures decentralized operation. Interoperability can allow integration with other blockchain networks for cross-platform transactions.

According to some embodiments, the crowdfunded auction system 1008 may be implemented using Artificial Intelligence and/or Machine Learning Models/techniques. AI-powered Services: Enhances personalization, recommendation, fraud detection, and optimization. Continuous learning can improves AI models over time with new data. Explainable AI helps ensure transparency and user trust in AI algorithms.

According to some embodiments, the crowdfunded auction system 1008 may provide Security and Privacy features. Encryption and access control can protect sensitive data using industry-standard algorithms. Secure development practices can follows secure software development practices to mitigate risks. Privacy-preserving techniques can implements techniques like differential privacy to maintain user privacy.

According to some embodiments, the crowdfunded auction system 1008 may be implemented using Continuous Integration and Deployment (CI/CD). Automated build and test can help ensures code quality and functionality through rigorous testing. Continuous deployment can provide rapid iteration and reduced manual intervention. Monitoring and observability can tracks system performance and detects anomalies in real-time.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

Although the preceding description describes various functions of a web server 1010, a sub-system 900 (of FIG. 9), and a database 1016 (FIG. 10), in some embodiments, some or all of these functions may be carried out by a single computing device.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. It is also contemplated that the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

As used in this application, the terms “component,” “module,” “system,” “server,” “processor,” “engine,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or. ” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The methods and systems of the present disclosure, as described above and shown in the drawings, provide for crowd funded, last bid wins auctions. While the apparatus and methods of the subject disclosure have been shown and described with reference to certain embodiments, those skilled in the art will readily appreciate that changes and/or modifications may be made thereto without departing from the scope of the subject disclosure.

What is claimed is:

1. A system for providing auction campaigns, the system comprising:
one or more processors; and
memory storing instructions that, when executed by the one or more processors, cause the system to:
receive, from a first user device associated with a campaigner, a campaign request, the campaign request comprising an indication of an item or service for offer and a reserve price;
publish, via a first graphical user interface, the indication of the item or service for offer in association with a campaign;
receive, from a plurality of second user devices, a plurality of pledges associated with the campaign within a first predetermined time period;
responsive to determining that a sum of the pledges received from the plurality of second user devices within the first predetermined time period exceeds the reserve price, validate the plurality of pledges within a second predetermined time period to generate a validated pledge sum;
responsive to determining that the validated pledge sum exceeds the reserve price:
transmit a notification to each user device of the plurality of second user devices that is associated with a validated pledge, the notification comprising a scheduled time for an auction of the item or service for auction; and
upon the occurrence of the scheduled time, establish electronic communication with each user device of the plurality of second user devices that is associated with a validated pledge to host a live auction of the item or service for auction.

2. The system as recited in claim 1, wherein the memory further comprises instructions that, when executed by the one or more processors, cause the system to:
responsive to determining that the sum of the pledges received from the plurality of second user devices within the first predetermined time period or the validated pledge sum does not exceed the reserve price, terminate the campaign.

3. The system as recited in claim 1, wherein the memory further comprises instructions that, when executed by the one or more processors, cause the system to:
issue reward points to a plurality of users of the plurality of second user devices in proportion to successfully validated pledges on a per user basis.

4. The system as recited in claim 3, wherein the memory further comprises instructions that, when executed by the one or more processors, cause the system to:
generate blockchain-based tokens that are paired at a platform-defined ratio with issued reward points;
enable the tokens to be redeemed for native platform benefits including participation in campaign-related auctions, discounts on store items, staking mechanisms for token yield, or governance rights in platform decision-making; and
record each point-token issuance and redemption event on both an internal user ledger and corresponding blockchain ledger for transparent tracking and reconciliation.

5. The system as recited in claim 3, wherein the memory further comprises instructions that, when executed by the one or more processors, cause the system to operate so at least one of:
token valuation is dynamically adjusted through a liquidity pool funded by a fixed percentage of campaign overpledge contributions;
a redemption mechanism applies a dynamic pricing rate based on the real-time token value in the liquidity pool;
all redeemed tokens are removed from circulation using a programmed burn or lockup protocol to preserve long-term token value;
unspent paired tokens remain accessible in a user wallet for use across future campaigns, auctions, or governance events;
a reward point issuance ratio is determined dynamically based on user contribution tier, campaign urgency, or time-based promotional rules;
bid tokens are granted based on non-monetary user engagement activities including, but not limited to, daily login streaks, campaign referrals, or verified social media sharing;
the reward point to blockchain token pairing is configured to include a lock-up period or delayed unlock schedule based on platform-defined governance settings; and/or
user staking of blockchain tokens grants enhanced platform privileges including discounted bid conversion, voting weight in campaign governance, or early access to auction participation.

6. The system as recited in claim 1, wherein the memory further comprises instructions that, when executed by the one or more processors, cause the system to:
receive user pledges toward a defined reward item or category offered via the platform's point-based store as a pledged item or item class;
launch an auction for the pledged item or item class once campaign funding is confirmed;
allow eligible users to place auction bids using expendable replay bids, bid credits, or platform-authorized bid tokens;
identify a single winning participant upon auction close and at least one non-winning participant;
credit each non-winning participant with one or more replay bids, optionally item-specific, campaign-class-specific, or generalized, based on predefined platform rules or auction parameters;
store replay bids in a persistent user-linked ledger and automatically apply them toward eligible future auctions of similar items, equivalent item categories, or platform-authorized reward events; and
upon a user participant winning an auction, clear associated replay bids linked to that auction from an account ledger of that user participant.

7. The system as recited in claim 6, wherein the memory further comprises instructions that, when executed by the one or more processors, cause the system to operate so at least one of:
replay bids are item-specific, non-transferable, and do not expire unless a corresponding item is permanently discontinued;
users may accumulate replay bids across multiple auction cycles and may be notified of their accrued advantage prior to bidding;
a replay bid threshold is established, after which the corresponding item may be auto-awarded to the user if unsuccessful in auction, or unlocked via store redemption;
replay bid issuance and redemption is logged via a real-time transaction tracker to promote transparent and fair auction participation. ;
replay bids expire after a predefined number of unsuccessful auction cycles or a platform-defined time window, whichever occurs first;
users may exchange a predefined number of replay bids for direct redemption of the corresponding item or a platform-authorized equivalent reward;
replay bid issuance is accompanied by a user interface element that visually notifies the participant of their accrued replay bid count and remaining eligibility; and/or
the system automatically tracks replay bid exhaustion and prompts users with personalized offers to reconvert reward points into fresh bid credits when applicable.

8. The system as recited in claim 1, wherein the memory further comprises instructions that, when executed by the one or more processors, cause the system to:
issue non-cash reward points in proportion to each verified pledge in the validated pledge sum;
convert the points into auction participation units including:
price-incrementing bids,
persistent replay bids applicable to future auctions for a same item or item class as in the campaign request, and
non-incrementing promotional bid tokens;
initiate the live auction as a last bid wins (LBW) auction, accessible only to users with verified pledges to the campaign request;
restrict access to reward allocation through the auction, wherein fulfillment is determined solely by the final valid bid submitted before auction close, representing a user-driven, skill-based outcome independent of random or chance-based elements; and
exclude any guaranteed reward allocation outside of the auction.

9. The system as recited in claim 8, wherein the memory further comprises instructions that, when executed by the one or more processors, cause the system to operate so at least one of:
users who do not win the auction are automatically issued replay bids tied to a same item or item class as in the campaign request;
all forms of auction participation are derived exclusively from non-cash reward points issued through verified pledge collection;
a persistent user-linked bid ledger tracks standard bids, replay bids, and bid token usage for transparency and reward eligibility;
auction fulfillment replaces traditional backer reward distribution and acts as the sole delivery mechanism for high-value items within the system; and/or
the system displays to users a status of their participation credits and accrued replay bids in real time.

10. The system as recited in claim 1, wherein the memory further comprises instructions that, when executed by the one or more processors, cause the system to:
detect when the validated pledge sum exceeds the reserve price;
responsive to the validated pledge sum exceeding the reserve price, execute an automated allocation module configured to distribute a surplus across a dynamic or predefined set of categories selected from the group consisting of: blockchain liquidity reserves, platform development initiatives, incentive programs, third-party integrations, cross-platform reward ecosystems, investment funds, ecosystem expansion efforts, user retention programs, external charitable contributions, and other platform-authorized purposes;
use a rule-based distribution engine to determine real-time routing percentages for each category based on a configurable allocation schema, campaign-specific criteria, or administrative override; and
displaying to users a live or historical breakdown of how their overpledged contribution is apportioned across applicable categories using a campaign impact dashboard.

11. The system as recited in claim 8, wherein the memory further comprises instructions that, when executed by the one or more processors, cause the system to operate so at least one of:
users with validated pledges are allowed cast votes weighted by platform tokens to influence allocation percentages of overpledged funds across eligible distribution categories;
the system dynamically adjusts routing schema for overpledged funds based on campaign type, seasonality, historical performance, or administrative configuration; and/or
charitable contributions from overpledged funds are distributed to verified nonprofit recipients that meet a platform-defined impact or compliance score threshold.

12. A computer-implemented method for managing a crowdfunding campaign with integrated reward progression, comprising:
receiving conditional pledges from a plurality of users toward a defined campaign goal via an online platform interface;
monitoring pledge transactions for the conditional pledges in real time, distinguishing between pledged intent and verified collection using a campaign tracking and fund validation engine;
responsive to a total pledged amount of verified collection from the pledge transactions meeting or exceeding the defined campaign goal, initiating a fund collection phase wherein each of the conditional pledges is processed through one or more payment processors and flagged as confirmed or failed;
displaying to the plurality of users a dynamic campaign status indicator that initially shows a percentage of the defined campaign goal pledged, and responsive to the defined campaign goal being reached, switches to reflect a percentage of funds successfully collected and verified, wherein the campaign is marked as funded only when a full amount of the defined campaign goal is confirmed;
transitioning the campaign to a funded state and continuing to accept verified pledge transactions until a scheduled campaign end time; and
responsive to reaching the campaign end time and confirming full fund collection, automatically triggering a reward event including an exclusive auction restricted to users with successfully verified contributions.

13. The method as recited in claim 12, further comprising:
responsive to the campaign meeting the defined campaign goal but failing to achieve full collection through verified transactions, enabling the plurality of users to select either a platform pledge credit equal to their original respective contribution or to donate the value to a designated charitable recipient.

14. The method as recited in claim 12, further comprising:
restricting access to any reward distribution, auction event, or platform benefit associated with the campaign until all pledged contributions have been successfully verified as collected, wherein the campaign is only eligible to transition once a full amount of the defined campaign goal is confirmed through system-enforced verification processes.

15. The method as recited in claim 12, further comprising updating an internal state and a public state of the campaign in real time based on pledge verification progress with transitions governed by verified collection thresholds.

16. The method of claim 12, further comprising sending stage-specific notifications to users at each campaign transition event.

17. The method of claim 12, wherein failed pledge transactions are subject to fallback mechanisms including automated retries, user-initiated payment updates, or substitution with alternative payment methods supported by the platform.

18. The method of claim 12, further comprising a manual administrative override module that allows a campaign to be promoted to funded status in exceptional circumstances, bypassing standard verification requirements.

19. The method of claim 12, wherein campaign goals are dynamically adjusted in real time based on participation trends, referral metrics, backer tiers, or promotional events.

20. The method of claim 11, wherein an auction event may be manually triggered by a platform administrator in cases where full verification is infeasible within the scheduled campaign duration; and/or
wherein users are notified when their pledges are at risk of validation failure and are offered alternative payment options or the ability to convert their pledge into a platform credit or donation.
